(19) United States
(12) Patent Application Publication
(10) Pub. No.: US 2010/0331443 A1
(43) Pub. Date: Dec. 30, 2010

(54) SILICONE HYDROGELS FORMED FROM SYMMETRIC HYDROXYL FUNCTIONALIZED SILOXANES

(76) Inventors: Diana Zanini, Jacksonville, FL (US); Jason Condrey, Neptune Beach, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/769,689

(22) Filed: Apr. 29, 2010

Related U.S. Application Data
(60) Provisional application No. 61/219,963, filed on Jun. 24, 2009.

(51) Int. Cl. G02B 1/04; C08L 83/00; C08L 39/06; B29C 41/00

(52) U.S. Cl. 523/107; 524/800; 524/808; 523/122; 264/299

(57) ABSTRACT

The present invention relates to a silicone hydrogel having at least about 20 weight % water, and formed from a reactive mixture comprising at least one non-reactive hydrophilic polymer and at least one symmetric, hydroxyl functionalized silicone monomer. Silicone hydrogels of the present invention may be formed from reaction mixtures which do not contain hydrophilic monomers.

### RELATED APPLICATIONS

This application claims priority from U.S. Provisional Application Ser. No. 61/219,963, filed Jun. 24, 2009.

### FIELD OF THE INVENTION

The present invention relates to silicone hydrogel polymers, molded articles formed from said silicone hydrogel polymers and processes for making said hydrogels and articles. More particularly, the present invention relates to silicone hydrogel polymers comprising a symmetrical hydroxyl functional silicone containing monomer and a hydrophilic polymer. Medical devices and methods for making said hydrogels and medical devices are also disclosed.

### BACKGROUND OF THE INVENTION

Silicone hydrogels have been prepared by polymerizing mixtures containing at least one silicone containing monomer and at least one hydrophilic monomer. Either the silicone containing monomer or the hydrophilic monomer may function as a crosslinking agent or a separate crosslinking agent may be employed. Various alcohols, including n-hexanol, ethanol, and n-nonanol have been used as diluents to compatibilize the silicone monomers and the hydrophilic monomers. However, the articles made from these components and diluents either did not form clear articles or were not sufficiently wettable to be used without a coating.

Primary and secondary alcohols having more than four carbon atoms have also been disclosed to be useful as diluents for silicone containing hydrogels. However, many of these diluents do not form clear, wettable articles when internal wetting agents are included in the reaction mixture. While these diluents are useful, many require an additional compatibilizing component to produce uncoated clear, wettable molded articles.

Symmetrical reactive silicone components have also been disclosed in the art.

Compounds having specific Hansen solubility parameters and Kamlet alpha values have also been disclosed to be useful as diluents for silicone hydrogels. However, many are not miscible with water, requiring the use of complicated solvent and water exchange processes. Thus, there still remains a need in the art for silicone hydrogels which are polymerized in an economic and efficient way which may yield medical devices such as uncoated clear contact lenses with wettable surfaces.

### SUMMARY OF THE INVENTION

The present invention further relates to silicone hydrogel polymers formed from reactive mixtures comprising, consisting essentially of and consisting of at least one symmetrical hydroxyl functionalized silicone monomer and at least one hydrophilic polymer. In some embodiments the reactive mixtures are substantially free of reactive hydrophilic components.

The present invention further relates to medical devices formed from said silicone hydrogel polymers.

The present invention further relates to processes for forming wettable silicone hydrogels comprising at least one organic diluent.

Still further the present invention relates to methods for manufacturing devices, specifically ophthalmic devices and more specifically contact lenses and the articles so made.

### DESCRIPTION OF THE DRAWING

FIG. 1 is a diagram showing lens molds which may be sued to make contact lenses.

### DETAILED DESCRIPTION OF THE SPECIFIC EMBODIMENTS

The present invention relates to silicone hydrogels compositions comprising at least one hydrophilic polymer, at least one symmetrical, hydroxyl-functionalized silicone-containing component. The silicone hydrogels of the present invention have water contents of at least about 20% and advancing dynamic contact angles of less than about 100° C. and in some embodiments less than about 80° C. In some embodiments the reactive mixture further comprises at least one diluent.

As used herein, “diluent” refers to a solvent for the reactive composition. Diluents do not react to form part of the biomedical devices.

As used herein, “symmetric hydroxyl functionalized siloxane” means a compound of the formula

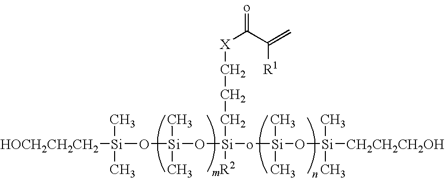

### Wherein R₁ is H or CH₃

### X is O or NH

R₂ is CH₃ or the Si moiety shown below:

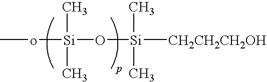

And m, n and p are individually an integer of 1-10.

In one embodiment, X is O, R₁ and R₂ are CH₃ and n and m are each 3. In another embodiment X is O, R₁ is CH₃, R₂ is a substituent of Formula II and n, m and p are each 3.

As used herein, a “biomedical device” is any article that is designed to be used while either in or on mammalian tissues or fluid, and in one embodiment in or on human tissue or fluids. Examples of these devices include but are not limited to catheters, implants, stents, and ophthalmic devices. In one embodiment the biomedical devices are ophthalmic devices, particularly contact lenses, most particularly contact lenses made from silicone hydrogels.

As used herein, the terms “ophthalmic device” refers to products that reside in or on the eye. These devices can provide optical correction, wound care, drug delivery, diagnostic functionality, cosmetic enhancement or effect or a combination of these properties. Non-limiting examples of ophthalmic devices include lenses, punctal plugs and the like. The term lens (or contact lens) includes but is not limited to soft contact lenses, hard contact lenses, intraocular lenses, overlay lenses, ocular inserts, and optical inserts.

All percentages in this specification are weight percentages unless otherwise noted.

As used herein, the phrase “without a surface treatment” or “not surface treated” means that the exterior surfaces of the devices of the present invention are not separately treated to improve the wettability of the device. Treatments which may be foregone because of the present invention include, plasma treatments, grafting, coating and the like. However, coatings which provide properties other than improved wettability, such as, but not limited to antimicrobial coatings and the application of color or other cosmetic enhancement, may be applied to devices of the present invention.

As used herein, the phrase “reactive mixture” refers to the mixture components, including, reactive components, diluent (if used), initiators, crosslinkers and additives, which when subjected to polymer forming conditions form a polymer. Reactive components are the components in the reaction mixture, which upon polymerization, become a permanent part of the polymer, either via chemical bonding or entrapment or entanglement within the polymer matrix. For example, reactive monomers become part of the polymer via polymerization, while non-reactive polymeric internal wetting agents, such as PVP, became part of the polymer via entrapment. The diluent (if used) and any additional processing aids, such as deblocking agents do not become part of the structure of the polymer and are not part of the reactive components.

As used herein, the phrase “hydrophilic polymer” refers to substances having a weight average molecular weight of no less than about 5,000 Daltons, wherein said substances upon incorporation to silicone hydrogel formulations, increase the wettability of the cured silicone hydrogels. In one embodiment the weight average molecular weight of these hydrophilic polymers is greater than about 30,000; in another between about 150,000 to about 2,000,000 Daltons. In yet another embodiment the molecular weight of the at least one hydrophilic polymer is between about 300,000 to about 1,800,000 Daltons, and in yet another about 500,000 to about 1,500,000 Daltons.

Alternatively, the molecular weight of hydrophilic polymers of the invention can be also expressed by the K-value, based on kinematic viscosity measurements, as described in Encyclopedia of Polymer Science and Engineering, N-Vinyl Amide Polymers, Second edition, Vol 17, pgs. 198-257, John Wiley & Sons Inc. When expressed in this manner, hydrophilic monomers having K-values of greater than about 46 and in one embodiment between about 46 and about 150. The hydrophilic polymers are present in the formulations of these devices in an amount sufficient to provide contact lenses and provide at least a 10% improvement in wettability and in some embodiments provide wettable lenses without surface treatments. For a contact lens, “wettable” is a lens which displays an advancing dynamic contact angle of less than about 80°, less than 70° and in some embodiments less than about 60°.

Examples of hydrophilic polymers include but are not limited to polyamides, polylactones, polyimides, polylactams and functionalized polyamides, polylactones, polyimides, polylactams, such as DMA functionalized by copolymerizing DMA with a lesser molar amount of a hydroxyl-functional monomer such as HEMA, and then reacting the hydroxyl groups of the resulting copolymer with materials containing radical polymerizable groups, such as isocyanatoethylmethacrylate or methacryloyl chloride. Hydrophilic prepolymers made from DMA or n-vinyl pyrrolidone with glycidyl methacrylate may also be used. The glycidyl methacrylate ring can be opened to give a diol which may be used in conjunction with other hydrophilic prepolymer in a mixed system to increase the compatibility of the hydrophilic polymer, hydroxyl-functionalized silicone containing monomer and any other groups which impart compatibility. In one embodiment the hydrophilic polymers contain at least one cyclic moiety in their backbone, such as but not limited to, a cyclic amide or cyclic imide. Hydrophilic polymers include but are not limited to poly-N-vinyl pyrrolidone, poly-N-vinyl-2-piperidone, poly-N-vinyl-2-caprolactam, poly-N-vinyl-3-methyl-2-caprolactam, poly-N-vinyl-3-methyl-2-piperidone, poly-N-vinyl-4-methyl-2-piperidone, poly-N-vinyl-4-methyl-2-caprolactam, poly-N-vinyl-3-ethyl-2-pyrrolidone, and poly-N-vinyl-4,5-dimethyl-2-pyrrolidone, polyvinylimidazole, poly-N—N-dimethylacrylamide, polyvinyl alcohol, polyacrylic acid, polyethylene-oxide, poly-2-ethyl-oxazoline, heparin polysaccharides, polysaccharides, mixtures and copolymers (including block or random, branched, multichain, comb-shaped or star shaped) thereof, where poly-N-vinylpyrrolidone (PVP) is particularly preferred in one embodiment. Copolymers might also be used such as graft copolymers of PVP.

The hydrophilic polymers provide wettability, and particularly in vivo wettability to the medical devices of the present invention. Without being bound by any theory, it is believed that the hydrophilic polymers are hydrogen bond receivers which in aqueous environments, hydrogen bond to water, thus becoming effectively more hydrophilic. The absence of water facilitates the incorporation of the hydrophilic polymer in the reaction mixture. Aside from the specifically named hydrophilic polymers, it is expected that any hydrophilic polymer will be useful in this invention provided that when said polymer is added to a silicone hydrogel formulation, the hydrophilic polymer (a) does not substantially phase separate from the reaction mixture and (b) imparts wettability to the resulting cured polymer. In some embodiments it is preferred that the hydrophilic polymer be soluble in the diluent at reaction temperatures.

The hydrophilic polymers may be present in the reactive mixtures of the present invention in amounts from about 5 to about 30 weight percent, in some embodiments about 5 to about 20 percent, in other embodiments about 6 to about 15 percent, all based upon the total of all reactive components.

It has been surprisingly found that by including at least one siloxane of Formula I and at least one hydrophilic polymer, silicone hydrogels having desirable water contents and contact angles may be made without including any reactive hydrophilic components. It was surprising that incorporating the hydrophilic polymers as the sole hydrophilic component could provide water contents in excess of about 20%.

The symmetric hydroxyl functionalized siloxane is present in the reaction mixture is from about 75 to 95 weight percent, in some embodiments about 75 to 90 weight percent of the reactive components in the reactive mixture

The reaction mixtures of the present invention may further comprise at least one diluent. The diluents useful in the present invention should have a polarity sufficiently low to solubilize the non-polar components in the reactive mixture at reaction conditions. One way to characterize the polarity of the co-diluents of the present invention is via the Hansen solubility parameter, δp. In certain embodiments, the δp of the co-diluents of the present invention is about 2 to about 7.

The selected diluents should also solubilize the components in the reactive mixture. It will be appreciated that the properties of the selected hydrophilic polymer and symmetric hydroxyl functionalized siloxane may affect the properties of the diluents which will provide the desired compatibilization. For example, if the reaction mixture contains only moderately polar components, diluents having moderate δp may be used. If however, the reaction mixture contains strongly polar components, the diluent may need to have a high δp.

Classes of suitable diluents include, without limitation, alcohols having 2 to 20 carbons and a carbon: oxygen from hydroxyl ratio of up to about 8:about 1, amides having 10 to 20 carbon atoms derived from primary amines. In some embodiments, primary and tertiary alcohols are preferred. In one embodiment alcohols having 5 to 20 carbons having a carbon: oxygen from hydroxyl ratio of about 3:about 1 to about 6:about 1 may be use as co-diluents.

Specific diluents which may be used include, without limitation, 2-octanol, tert-amyl alcohol, tert-butanol, 2-butanol, 1-butanol, 2-propanol, 1-propanol, ethanol, 2-(diisopropylamino)ethanol, TPME 3-methyl-3-pentanol (3M3P), 3,7-dimethyl-3-octanol (D30), mixtures thereof and the like. The diluents may also comprise codiluents protonated diluents, including carboxylic acids having 6 to 18 carbon atoms, and phenols substituted with C₆₋₁₀ alkyl groups. In one embodiment the protonated diluent is selected from decanoic acid, hexanoic acid, octanoic acid, dodecanoic acid, mixtures thereof and the like. Alternatively, protonatable diluents, (diluents which can accept a proton) such as amines having 6-14 carbon atoms may be used. The protonatable diluents are included in the reactive mixture in their deprotonated form and protonated during lens processing. Examples of suitable protonatable diluents include decylamine, octylamine, hexylamine, mixtures thereof and the like.

The diluents may be used in amounts from about 20 to about 60% by weight of the total of all components in the reactive mixture. In one embodiment the diluent(s) are used in amounts less than about 50% and in another in amounts between about 30 and about 45% by weight of the total of all components in the reactive mixture. It has been surprisingly found that when the diluents of the present invention are used, wettable ophthalmic products having improved optical properties may be made, even when aqueous processing conditions are employed.

It is generally necessary to add one or more cross-linking agents, also referred to as cross-linking monomers, to the reaction mixture, such as ethylene glycol dimethacrylate (“EGDMA”), trimethylolpropane trimethacrylate (“TMPTMA”), glycerol trimethacrylate, polyethylene glycol dimethacrylate (wherein the polyethylene glycol preferably has a molecular weight up to, e.g., about 5000), and other polyacrylate and polymethacrylate esters, such as the end-capped polyoxyethylene polyols described above containing two or more terminal methacrylate moieties. The cross-linking agents are used in the usual amounts, e.g., from about 0.000415 to about 0.0156 mole per 100 grams of reactive components in the reaction mixture. (The reactive components are everything in the reaction mixture except the diluent and any additional processing aids which do not become part of the structure of the polymer.) Alternatively, if the hydrophilic monomers and/or the silicone containing monomers act as the cross-linking agent, the addition of a crosslinking agent to the reaction mixture is optional. Examples of hydrophilic monomers which can act as the crosslinking agent and when present do not require the addition of an additional crosslinking agent to the reaction mixture include polyoxyethylene polyols described above containing two or more terminal methacrylate moieties.

An example of a silicone containing monomer which can act as a crosslinking agent and, when present, does not require the addition of a crosslinking monomer to the reaction mixture includes α,ω-bismethacryloypropyl polydimethylsiloxane.

The reactive mixture may contain additional components such as, but not limited to, UV absorbers, medicinal agents, antimicrobial compounds, reactive tints, pigments, copolymerizable and nonpolymerizable dyes, release agents and combinations thereof. A polymerization catalyst is preferably included in the reaction mixture. The polymerization initiators include compounds such as lauryl peroxide, benzoyl peroxide, isopropyl percarbonate, azobisisobutyronitrile, and the like, that generate free radicals at moderately elevated temperatures, and photoinitiator systems such as aromatic alpha-hydroxy ketones, alkoxyoxybenzoins, acetophenones, acylphosphine oxides, bisacylphosphine oxides, and a tertiary amine plus a diketone, mixtures thereof and the like. Illustrative examples of photoinitiators are 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide (DMBAPO), bis(2,4,6-trimethylbenzoyl)-phenyl phosphineoxide (Irgacure 819), 2,4,6-trimethylbenzyldiphenyl phosphine oxide and 2,4,6-trimethylbenzoyl diphenylphosphine oxide, benzoin methyl ester and a combination of camphorquinone and ethyl 4-(N,N-dimethylamino)benzoate. Commercially available visible light initiator systems include Irgacure 819, Irgacure 1700, Irgacure 1800, Irgacure 819, Irgacure 1850 (all from Ciba Specialty Chemicals) and Lucirin TPO initiator (available from BASF). Commercially available UV photoinitiators include Darocur 1173 and Darocur 2959 (Ciba Specialty Chemicals). These and other photoinitiators which may be used are disclosed in Volume III, Photoinitiators for Free Radical Cationic & Anionic Photopolymerization, 2^{nd} Edition by J. V. Crivello & K. Dietliker; edited by G. Bradley; John Wiley and Sons; New York; 1998, which is incorporated herein by reference. The initiator is used in the reaction mixture in effective amounts to initiate photopolymerization of the reaction mixture, e.g., from about 0.1 to about 2 parts by weight per 100 parts of reactive monomer. Polymerization of the reaction mixture can be initiated using the appropriate choice of heat or visible or ultraviolet light or other means depending on the polymerization initiator used. Alternatively, initiation can be conducted without a photoinitiator using, for example, e-beam. However, in one embodiment when a photoinitiator is used, preferred initiators induce bisacylphosphine oxides, such as bis(2,4,6-trimethylbenzoyl)-phenyl phosphine oxide (Irgacure 819®) or a combination of 1-hydroxycyclohexyl phenyl ketone and bis(2,6-dimethoxybenzoyl)-2,4-4-trimethylpentyl phosphine oxide (DMBAPO), and a preferred method of polymerization initiation is visible light. A preferred is bis(2,4,6-trimethylbenzoyl)-phenyl phosphine oxide (Irgacure 819®).

Combinations of reactive components and diluents include those having from about 75 to about 95 weight % symmetric hydroxyl functionalized silicone, from about 0.2 to about 3 weight % of a crosslinker, from about 0 to about 3 weight % of a UV absorbing monomer, from about 5 to about 30 weight % of a hydrophilic polymer (all based upon the weight % of all reactive components) and about 20 to about 60 weight % (weight % of all components, both reactive and non-reactive) of one or more diluents.

The reaction mixtures of the present invention can be formed by any of the methods known to those skilled in the art, such as shaking or stirring, and used to form polymeric articles or devices by known methods.

For example, the biomedical devices of the invention may be prepared by mixing reactive components and the diluent(s) with a polymerization initiator and curing by appropriate conditions to form a product that can be subsequently formed into the appropriate shape by lathing, cutting and the like. Alternatively, the reaction mixture may be placed in a mold and subsequently cured into the appropriate article.

Various processes are known for processing the reaction mixture in the production of contact lenses, including spincasting and static casting. Spincasting methods are disclosed in U.S. Pat. Nos. 3,408,429 and 3,660,545, and static casting methods are disclosed in U.S. Pat. Nos. 4,113,224 and 4,197,266. In one embodiment, the method for producing contact lenses comprising the polymer of this invention is by the direct molding of the silicone hydrogels, which is economical, and enables precise control over the final shape of the hydrated lens. For this method, the reaction mixture is placed in a mold having the shape of the final desired silicone hydrogel, i.e., water-swollen polymer, and the reaction mixture is subjected to conditions whereby the monomers polymerize, to thereby produce a polymer/diluent mixture in the shape of the final desired product.

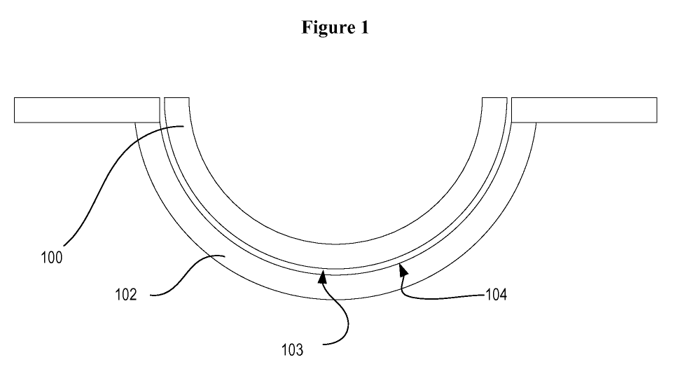

Referring to FIG. 1, a diagram is illustrated of an ophthalmic lens 100, such as a contact lens, and mold parts 101-102 used to form the ophthalmic lens 100. In some embodiments, the mold parts include a back surface mold part 101 and a front surface mold part 102. As used herein, the term “front surface mold part” refers to the mold part whose concave surface 104 is a lens forming surface used to form the front surface of the ophthalmic lens. Similarly, the term “back surface mold part” refers to the mold part 101 whose convex surface 105 forms a lens forming surface, which will form the back surface of the ophthalmic lens 100. In some embodiments, mold parts 101 and 102 are of a concavo-convex shape, preferably including planar annular flanges, which surround the circumference of the uppermost edges of the concavo-convex regions of the mold parts 101-102.

Typically, the mold parts 101-102 are arrayed as a “sandwich”. The front surface mold part 102 is on the bottom, with the concave surface 104 of the mold part facing upwards. The back surface mold part 101 can be disposed symmetrically on top of the front surface mold part 102, with the convex surface 105 of the back surface mold part 101 projecting partially into the concave region of the front surface mold part 102. In one embodiment, the back surface mold part 101 is dimensioned such that the convex surface 105 thereof engages the outer edge of the concave surface 104 of the front mold part 102 throughout its circumference, thereby cooperating to form a sealed mold cavity in which the ophthalmic lens 100 is formed.

In some embodiments, the mold parts 101-102 are fashioned of thermoplastic and are transparent to polymerization-initiating actinic radiation, by which is meant that at least some, and in some embodiments all, radiation of an intensity and wavelength effective to initiate polymerization of the reaction mixture in the mold cavity can pass through the mold parts 101-102.

For example, thermoplastics suitable for making the mold parts can include: polystyrene; polyvinylchloride; polyolefin, such as polyethylene and polypropylene; copolymers or mixtures of styrene with acrylonitrile or butadiene, polyacrylonitrile, polyamides, polyesters, cyclic olefin copolymers such as Topas available from Ticona or Zeonor available from Zeon, combinations of any of the foregoing, or other known material.

Following polymerization of the reaction mixture to form a lens 100, the lens surface 103 will typically adhere to the mold part surface 104. The steps of the present invention facilitate release of the surface 103 from the mold part surface.

The first mold part 101 can be separated from the second mold part 102 in a demolding process. In some embodiments, the lens 100 will have adhered to the second mold part 102 (i.e. the front curve mold part) during the cure process and remain with the second mold part 102 after separation until the lens 100 has been released from the front curve mold part 102. In other embodiments, the lens 100 can adhere to the first mold part 101.

The lens 100 and the mold part to which it is adhered after demolding may be contacted with a release solution. The release solution can be heated to any temperature below the boiling point of the release solution.

As used herein, processing includes the steps of removing the lens from the mold and removing or exchanging the diluent with an exchange solution. The steps may be done separately, or in a single step or stage. The processing temperature may be any temperatures between about 30° C. and the boiling point of the aqueous solutions, in some embodiments between about 30° C. and about 95° C., and in some embodiments between about 50° C. and about 95° C.

The exchange solutions may be aqueous or organic solutions. In some embodiments it may be desirable to use an organic solution for the exchange solution in at least one zone. Suitable organic exchange solutions may comprise isopropyl alcohol, propylene glycol, TPME, EtOH, hexanol, water and mixtures thereof. In one embodiment, the exchange solution comprises isopropyl alcohol. In some embodiments, the exchange solution is an aqueous solution, which may in one embodiment comprise at least about 70 wt % water, and in other embodiments at least about 90 weight % water and in other embodiments at least about 95% water. The aqueous solution may also be a contact lens packaging solution such as borate buffered saline solution, sodium borate solutions, sodium bicarbonate solutions and the like. The aqueous solution may also include additives, such as surfactants, preservatives, release aids, antibacterial agents, pharmaceutical and nutriceutical components, lubricants, wetting agents, salts, buffers, mixtures thereof and the like. Specific examples of additives which may be included in the aqueous solution include Tween 80, which is polyoxyethylene sorbitan monooleate, Tyloxapol, octylphenoxy(oxyethylene)ethanol, amphoteric 10), EDTA, sorbic acid, DYMED, chlorhexadine gluconate, hydrogen peroxide, thimerosal, polyquad, polyhexamethylene biguanide, mixtures thereof and the like. Where various zones are used, different solutions may be used, and different additives may be included in different zones. For example, where the exchange solution comprises isopropyl alcohol, the first zone may comprise about 90% or more isopropyl alcohol, and subsequent zones may comprise mixtures of isopropyl alcohol and water, which are successively more dilute. The final exchange solution may be 100% aqueous. In some embodiments, additives can be added to the exchange solution in amounts varying between 0.01% and 10% by weight, but cumulatively less than about 10% by weight.

Exposure of the ophthalmic lens 100 to the exchange solution can be accomplished by any method, such as washing, spraying, soaking, submerging, or any combination of the aforementioned. For example, in some embodiments, the lens 100 can be washed with an aqueous solution comprising deionized water in a hydration tower.

In embodiments using a hydration tower, front curve mold parts 102 containing lenses 100 can be placed in pallets or trays and stacked vertically. The exchange solution can be introduced at the top of the stack of lenses 100 so that the solution will flow downwardly over the lenses 100. The solution can also be introduced at various positions along the tower. In some embodiments, the trays can be moved upwardly allowing the lenses 100 to be exposed to increasingly fresher solution.

In other embodiments, the ophthalmic lenses 100 are soaked or submerged in the exchange solution.

The contacting step can last up to about 12 hours, in some embodiments up to about 2 hours and in other embodiments from about 2 minutes to about 2 hours; however, the length of the contacting step depends upon the lens materials, including any additives, the materials that are used for the exchange solutions or solvents, and the temperatures of the solutions. Sufficient treatment times typically shrink the contact lens and release the lens from the mold part. Longer contacting times will provide greater leaching.

The volume of exchange solution used may be any amount greater than about 1 ml/lens and in some embodiments greater than about 5 ml/lens.

In some methods, after separation or demolding, the lenses on the front curves, which may be part of a frame, are mated with individual concave slotted cups to receive the contact lenses when they release from the front curves. The cups can be part of a tray. Examples can include trays with 32 lenses each, and 20 trays that can be accumulated into a magazine.

According to another embodiment of the present invention the lenses are submerged in the exchange solution. In one embodiment, magazines can be accumulated and then lowered into tanks containing the exchange solution. The aqueous solution may also include other additives as described above.

The ophthalmic products, and particularly ophthalmic lenses of the present invention have a balance of properties which makes them particularly useful. Such properties include clarity, optics, water content, oxygen permeability and contact angle. Thus, in one embodiment, the biomedical devices are contact lenses having a water content of greater than about 20% and in some embodiments greater than about 25%.

As used herein clarity means substantially free from visible haze. Clear lenses have a haze value of less than about 150%, more preferably less than about 100% compared to a CSI lens.

Suitable oxygen permeabilities include those greater than about 40 barrer and in some embodiments greater than about 60 barrer.

Also, the biomedical devices, and particularly ophthalmic devices and contact lenses have average contact angles (advancing) which are less than about 80°, less than about 75° and in some embodiments less than about 70°. In some embodiments the articles of the present invention have combinations of the above described oxygen permeability, water content and contact angle. All combinations of the above ranges are deemed to be within the present invention.

### Hansen Solubility Parameter

The Hansen solubility parameter, δp may be calculated by using the group contribution method described in Barton, CRC Handbook of Solubility Par., 1st. Ed. 1983, page 85-87 and using Tables 13, 14.

### Haze Measurement

Haze is measured by placing a hydrated test lens in borate buffered saline in a clear 20×40×10 mm glass cell at ambient temperature above a flat black background, illuminating from below with a fiber optic lamp (Titan Tool Supply Co. fiber optic light with 0.5″ diameter light guide set at a power setting of 4-5.4) at an angle 66° normal to the lens cell, and capturing an image of the lens from above, normal to the lens cell with a video camera (DVC 1300C:19130 RGB camera with Navitar TV Zoom 7000 zoom lens) placed 14 mm above the lens platform. The background scatter is subtracted from the scatter of the lens by subtracting an image of a blank cell using EPIX XCAP V 1.0 software. The subtracted scattered light image is quantitatively analyzed, by integrating over the central 10 mm of the lens, and then comparing to a −1.00 diopter CSI Thin Lens®, which is arbitrarily set at a haze value of 100, with no lens set as a haze value of 0. Five lenses are analyzed and the results are averaged to generate a haze value as a percentage of the standard CSI lens. Lenses have haze levels of less than about 150% (of CSI as set forth above) and in some embodiments less than about 100%.

### Water Content

The water content of contact lenses was measured as follows: Three sets of three lenses are allowed to sit in packing solution for 24 hours. Each lens is blotted with damp wipes and weighed. The lenses are dried at 60° C. for four hours at a pressure of 0.4 inches Hg or less. The dried lenses are weighed. The water content is calculated as follows:

$$\% water content = \frac{( wet weight - dry weight )}{wet weight} \times 100$$

The average and standard deviation of the water content are calculated for the samples and are reported.

### Modulus

Modulus is measured by using the crosshead of a constant rate of movement type tensile testing machine equipped with a load cell that is lowered to the initial gauge height. A suitable testing machine includes an Instron model 1122. A dog-bone shaped sample having a 0.522 inch length, 0.276 inch “ear” width and 0.213 inch “neck” width is loaded into the grips and elongated at a constant rate of strain of 2 in/min. until it breaks. The initial gauge length of the sample (Lo) and sample length at break (Lf) are measured. Twelve specimens of each composition are measured and the average is reported. Percent elongation is=[(Lf−Lo)/Lo]×100. Tensile modulus is measured at the initial linear portion of the stress/strain curve.

### Advancing Contact Angle

The advancing contact angle was measured as follows. Four samples from each set were prepared by cutting out a center strip from the lens approximately 5 mm in width and equilibrated in packing solution. The wetting force between the lens surface and borate buffered saline is measured at 23° C. using a Wilhelmy microbalance while the sample is being immersed into or pulled out of the saline. The following equation is used

F=2γp cos θ or θ=cos⁻¹(F/2γp)

where F is the wetting force, γ is the surface tension of the probe liquid, p is the perimeter of the sample at the meniscus and θ is the contact angle. The advancing contact angle is obtained from the portion of the wetting experiment where the sample is being immersed into the packing solution. Each sample was cycled four times and the results were averaged to obtain the advancing contact angles for the lens.

### Oxygen Permeability (Dk)

The Dk is measured as follows. Lenses are positioned on a polarographic oxygen sensor consisting of a 4 mm diameter gold cathode and a silver ring anode then covered on the upper side with a mesh support. The lens is exposed to an atmosphere of humidified 2.1% O₂. The oxygen that diffuses through the lens is measured by the sensor. Lenses are either stacked on top of each other to increase the thickness or a thicker lens is used. The L/Dk of 4 samples with significantly different thickness values are measured and plotted against the thickness. The inverse of the regressed slope is the Dk of the sample. The reference values are those measured on commercially available contact lenses using this method. Balafilcon A lenses available from Bausch & Lomb give a measurement of approx. 79 barrer. Etafilcon lenses give a measurement of 20 to 25 barrer. (1 barrer=10⁻¹⁰ (cm³ of gas×cm²)/(cm³ of polymer×sec×cm Hg)).

The Examples below further describe this invention, but do not limit the invention. They are meant only to suggest a method of practicing the invention. Those knowledgeable in the field of contact lenses as well as other specialties may find other methods of practicing the invention. However, those methods are deemed to be within the scope of this invention.

Some of the other materials that are employed in the Examples are identified as:
Norbloc 2-(2′-hydroxy-5-methacrylyloxyethylphenyl)-2H-benzotriazole
PVP poly(N-vinyl pyrrolidone) (K value 90)
TEGDMA tetraethyleneglycol dimethacrylate
CGI 819 bis(2,4,6-trimethylbenzoyl)-phenyl phosphine oxide
MC-12 siloxane macromer of Formula I, wherein X=O, R¹ and R²═CH₃, m and n each are 3, available from Gelest
HO-PDMS mono-(3-methacryloxy-2-hydroxypropyloxy)propyl terminated, mono-butyl terminated polydimethylsiloxane (MW 612), prepared as in Example 28 of US-2008-0103231
t-amyl t-amyl alcohol
TPME tripropylene glycol methyl ether
Packing Solution A solution of about 0.185 weight % sodium borate, 0.926 weight % boric acid and 98.89 weight % water

### Examples 1-5

Separate reaction mixtures (Table 1) with different monomer: diluent ratios were mixed in a jar roller at 25(±3)° C. for a minimum of 16 hours and then degassed on high vacuum 700 mmHg, 25(±3)° C., for 30(±3) minutes. All reactive mixtures were free of haze. In a glove box, the reaction mixtures were each dosed into thermoplastic front curve contact lenses molds made from Zeonor, thermoplastic back curve contact lenses molds made from polypropylene were placed on top of the front curve molds, weights (quartz plates) were placed on the closed molds, and then the molds were cured under UV light [1.5-2.0 mWatts, 12-18 inches] at 55(±5)° C., under a nitrogen atmosphere (<0.5% O₂), for a period of 25 minutes. The resulting lenses were hand demolded and released in packing solution at 90° C. within 1-5 minutes. Lenses were then transferred to a 400 mL jar with packing solution and rolled for 30 minutes (maximum 100 lenses/jar). The packing solution was then decanted and fresh packing solution added and rolled for 30 minutes, then decanted a second time and fresh packing solution added and rolled overnight. Once the lenses were equilibrated they were inspected in fresh packing solution. The lenses were then packaged in vials containing 5 mL of packing solution, capped and sterilized at 121° C. for 30 minutes. Lens properties results are shown below in (Table 2).

TABLE 1
Reactive Monomer Mixtures

| | Example# | | | | |
|---|---|---|---|---|---|
| | 1 | 2 | 3 | 4 | 5 |
| | Monomer/Diluent | | | | |
| | 50/50 | 60/40 | 70/30 | 80/20 | 80/20 |
| Component | Wt % | Wt % | Wt % | Wt % | Wt % |
| Norbloc | 2.2 | 2.2 | 2.2 | 2.2 | 2.2 |
| CGI 819 | 0.25 | 0.25 | 0.25 | 0.25 | 0.25 |
| MC 12 | 84.55 | 84.55 | 84.55 | 84.55 | 84.55 |
| TEGDMA | 3 | 3 | 3 | 3 | 3 |
| DMA | 0 | 0 | 0 | 0 | 0 |
| HEMA | 0 | 0 | 0 | 0 | 0 |
| Blue Hema | 0 | 0 | 0 | 0 | 0 |
| PVP K90 | 10 | 10 | 10 | 10 | 10 |
| Monomer % | 100% | 100% | 100% | 100% | 100% |
| Diluent Ratio | | | | | |
| TPME | 100 | 55 | 55 | 55 | 0 |
| 1-Decanoic Acid | 0 | 45 | 45 | 45 | 0 |
| T-Amyl Alcohol | 0 | 0 | 0 | 0 | 100 |
| Total Diluent % | 100% | 100% | 100% | 100% | 100% |

TABLE 2
Lens Properties For Monomer Mixtures in Table 1

| | Example # | | | | |
|---|---|---|---|---|---|
| | 1 | 2 | 3 | 4 | 5 |
| | Monomer/Diluent | | | | |
| | 50/50 | 60/40 | 70/30 | 80/20 | 80/20 |
| Modulus (psi) | 29.7 (1.1) | — | — | — | — |
| Elongation (%) | 70.6 (14.2) | — | — | — | — |
| Tensile (psi) | 12.6 (2.2) | — | — | — | — |
| Toughness (in | 4.4 (1.9) | — | — | — | — |
| lb/in3) | | | | | |
| Gravimetric (%) | 39.5 (0.1) | 37.6 (0.2) | 39.8 (0.1) | 36.6 (0.1) | 37.9 (0.2) |
| DCA (adv Angle) | 98 (1) | 72 (21) | 85 (4) | 79 (3) | 84 (4), 83 (6)* |
| Dk (Dk units) | — | — | — | — | — |
| Haze (% CSI) | 160 (45) | — | — | 197 (6), 185 (62)* | 229 (29) |
| Refractive Index | 1.43 (0.0004) | — | — | — | — |

— = Not Determined
*measured twice, both values reported

### Comparative Example 1

Example 4 was repeated except that MC-12 was replaced with HO-PDMS. The reactive mixture was mixed on a jar roller at 25(±3)° C. for a minimum of 16 hours. The reactive mixture remained opaque throughout mixing. Lenses were not made.

### Examples 6-7

Examples 4 and 5 were repeated except that (a) the diluents listed in Table 3 and in the amounts listed in Table 3 were used and (b) the resulting lenses were demolded and released as follows. The lenses were hand demolded in a 90:10 IPA/DI water mixture after 20 minutes. Once the lenses released from the front curves, they were placed in a fresh 90:10 IPA/DI water solution and rolled for 30 minutes. The solution was decanted and fresh 90:10 IPA/DI water solution was added and the lenses were rolled for 30 minutes. The hydration process continued with the same procedure above followed by 70:30 IPA/DI water (2×), 50:50 IPA/DI water (2×), 30:70 IPA/DI Water (2×), and 100% DI water rolling the lenses for 30 minutes each interval. Finally the lenses were equilibrated in packing solution. Once the lenses were equilibrated they were inspected in fresh packing solution. The lenses were then packaged in vials containing 5 mL of packing solution, capped and sterilized at 121° C. for 30 minutes. Lens properties results are shown below in (Table 4).

TABLE 3
Reactive Monomer Mixtures

Example #

| | |
|---|---|
| 6 | 7 |

Monomer/Diluent

| | 80/20 | 80/20 |
|---|---|---|
| | Weight % | Weight % |
| Component | | |
| Norbloc | 2.2 | 2.2 |
| CGI 819 | 0.25 | 0.25 |
| MC 12 | 84.55 | 84.55 |
| TEGDMA | 3 | 3 |
| DMA | 0 | 0 |
| HEMA | 0 | 0 |
| Blue Hema | 0 | 0 |
| PVP K90 | 10 | 10 |
| Monomer % | 100% | 100% |
| Diluent Ratio | | |
| TPME | 55 | 0 |
| 1-Decanoic Acid | 45 | 0 |
| T-Amyl Alcohol | 0 | 100 |
| Total Diluent % | 100% | 100% |

TABLE 4
Lens Properties For Examples 4-7

| Example # | 4 | 6 | 5 | 7 | |
|---|---|---|---|---|---|
| Modulus (psi) | — | — | — | 497.9 | (52.1) |
| Elongation (%) | — | — | — | 64.3 | (8.7) |
| Tensile (psi) | — | — | — | 147.8 | (18.7) |
| Toughness (in lb/in3) | — | — | — | 44.9 | (12.1) |
| Gravimetric (%) | 36.6 (0.1) | 21.0 (0.1) | 37.9 (0.2) | 21.7 (1), 22.1 (0.3)* | |
| DCA (adv Angle) | 79 (3) | 75.5 (5) | 84 (4), 83 (6)* | 51 (4), 58 (4)* | |
| Dk (Dk units) | — | 45, 47* | — | 49 | |
| Haze (% CSI) | 197 (6), 185 (62)* | 133 (23) | 229 (29) | 106 | (22) |

— = Not Determined
*measured twice, both values reported

Comparing Examples 4 and 5 to Examples 6 and 7 respectively, it can be seen that using an organic solvent such as IPA for release and solvent exchange has a substantial impact on the % haze of the resulting contact lenses. Example 7 also shows that use of t-amyl alcohol as the diluent and the organic solvent exchange also provides substantially improved advancing dynamic contact angles compared to use of an organic solvent with a diluent other the t-amyl, or with t-amyl alcohol and aqueous extraction.

What is claimed is:

1. A silicone hydrogel comprising at least about 20 weight % water, and formed from a reactive mixture comprising at least one non-reactive hydrophilic polymer and at least one symmetric, hydroxyl functionalized silicone of Formula I 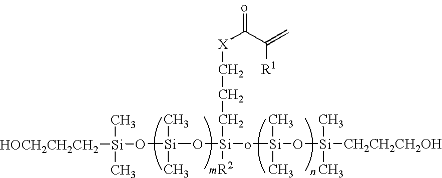
Wherein R₁ is H or CH₃
X is O or NH
R₂ is CH₃ or a silicone moiety of formula II: 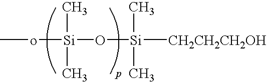
And m, n and p are individually an integer of 1-10.

2. The silicone hydrogel of claim 1 wherein said reactive mixture comprises from about 60 to about 95 weight percent symmetric, hydroxyl functionalized silicone based upon all reactive components in the reaction mixture.

3. The silicone hydrogel of claim 1 wherein said reactive mixture comprises from about 60 to about 90 weight percent symmetric, hydroxyl functionalized silicone based upon all reactive components in the reaction mixture.

4. The silicone hydrogel of claim 1 wherein said reactive mixture comprises from about 5 to about 30 weight percent hydrophilic polymer based upon the total of all reactive components.

5. The silicone hydrogel of claim 1 wherein said reactive mixture comprises from about 5 to about 17 weight percent hydrophilic polymer based upon the total of all reactive components.

6. The silicone hydrogel of claim 1 wherein said reactive mixture comprises from about 6 to about 15 weight percent hydrophilic polymer based upon the total of all reactive components.

7. The silicone hydrogel of claim 1 wherein the hydrophilic polymer comprises poly-N-vinylpyrrolidone.

8. The silicone hydrogel of claim 1 wherein said reactive mixture further comprises at least one diluent.

9. The silicone hydrogel of claim 8 wherein said diluent is selected from the group consisting of t-amyl alcohol, TPME, D30 mixtures thereof and the like.

10. The silicone hydrogel of claim 8 wherein said diluent is selected from t-amyl alcohol, TPME and mixtures of TPME and decanoic acid and 1,2-octanediol.

11. The silicone hydrogel of claim 8 wherein said reactive mixture comprises about 20 to about 60 weight % diluent.

12. The silicone hydrogel of claim 8 wherein said reactive mixture comprises about 30 to about 55 weight % diluent.

13. The silicone hydrogel of claim 1 further comprising at least one additional component selected from the group consisting of initiators, crosslinkers, UV absorbers, medicinal agents, antimicrobial compounds, reactive tints, pigments, copolymerizable and nonpolymerizable dyes, release agents and combinations thereof.

14. A process for forming a silicone hydrogel article comprising
(a) curing in a mold a reactive mixture comprising at least one diluent, at least one non-reactive hydrophilic polymer and at least one symmetric, hydroxyl functionalized silicone of Formula I 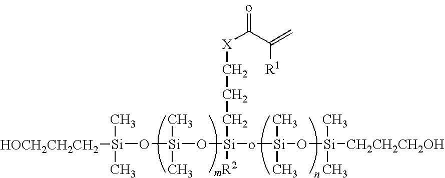
wherein R₁ is H or CH₃
X is O or NH
R₂ is CH₃ or 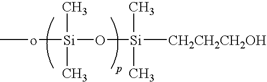
and m, n and p are individually an integer of 1-10 to form a silicone hydrogel article; and
(b) contacting said mold containing said silicone hydrogel article with a organic solution under conditions sufficient to release said silicone hydrogel article from said mold; and
(c) exchanging said organic solution with water to form a silicone hydrogel article having an advancing dynamic contact angle of less than about 75°.

15. The process of claim 14 wherein said contact angle is less than about 60°.

16. A contact lens formed from the silicone hydrogel of any of claims 1-13.
